(19) United States
(12) Patent Application Publication
(10) Pub. No.: US 2026/0099039 A1
(43) Pub. Date: Apr. 9, 2026

(54) MOVABLE MAGNETIC ADAPTER FOR DIGISCOPING

(71) Applicant: Epoch Outdoors LLC, Bozeman, MT (US)

(72) Inventor: Bruce Weston Clark, Bozeman, MT (US)

(21) Appl. No.: 19/352,229

(22) Filed: Oct. 7, 2025

Related U.S. Application Data
(60) Provisional application No. 63/704,639, filed on Oct. 8, 2024.

(51) Int. Cl. G02B 23/24; H04M 1/02

(52) U.S. Cl. CPC G02B 23/2484; G02B 23/243; H04M 1/0264

(57) ABSTRACT

A digiscoping system may include an adapter configured to attach to a camera device and an eyepiece configured to attach to an optic. The adapter includes a base with one or more magnets configured to magnetically couple to one or more magnets of a camera device, one or more openings, one or more aperture magnets disposed about each of the one or more openings, and one or more stopping components configured to align with an alignment magnet of the camera device. The eyepiece includes a central opening and one or more recesses configured to be removably coupled to the one or more aperture magnets. The digiscoping system is configured to removably secure and align one or more camera lenses of the camera device with an optic when the eyepiece is coupled about an optical axis of the optic.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. The present application claims the benefit of priority to U.S. Provisional Application No. 63/704,639, filed Oct. 8, 2024, the entire contents of which are hereby incorporated by reference.

### FIELD

The technology relates to digiscoping, in particular to systems for coupling components such as optics and imaging devices.

### BACKGROUND

Digiscoping is an afocal photography technique in which a camera device, such as a smartphone or other camera-enabled device, is used to capture images or video through the eyepiece of an optic, such as a spotting scope, binoculars, or a telescope. This process often presents challenges in terms of aligning the camera lens with the eyepiece of the optic in a quick and secure manner.

Existing digiscoping systems have notable limitations. Many require custom cases or base plates that restrict the user's options, degrade the overall user experience, or remain permanently attached to the phone, causing inconvenience during everyday use. These limitations can lead to slower setup times, misalignment, and missed photographic opportunities.

Accordingly, a need exists for a digiscoping system that can be used on a camera device without a custom base plate or case enveloping the device while allowing a user to quickly and easily align the optic and adapter and couple attachments to the system.

### SUMMARY

Various embodiments of systems, methods, and devices within the scope of the present disclosure each have several aspects, no single one of which is solely responsible for the desirable attributes herein. Without limiting the scope of this disclosure, its more prominent features will now be briefly discussed. After considering this discussion, and particularly after reading the section entitled, “Detailed Description” one will understand how the features of the examples described herein provide advantages to providing a digiscoping adapter.

Systems, devices, and methods are described herein for an adapter for magnetically coupling one or more optics with a camera device. The adapter can couple to one or more optics devices to a camera device. The digiscoping adapter can be coupled to the camera device for adjusting the alignment of the one or more optics devices with a camera lens of the camera device.

In a first aspect, a digiscoping system includes an adapter and an eyepiece. The adapter includes a base including one or more magnets configured to magnetically couple to one or more magnets of a camera device; one or more openings; one or more aperture magnets disposed about each of the one or more openings; and one or more stopping components configured to align with an alignment magnet of the camera device. The eyepiece includes a central opening and one or more recesses configured to be removably coupled to the one or more aperture magnets. The digiscoping system is configured to removably secure and align one or more camera lenses of the camera device with an optic when the eyepiece is coupled about an optical axis of the optic.

In some embodiments, the one or more magnets are arranged in a circle along a first surface of the adapter.

In some embodiments, the one or more front magnets are arranged in a MagSafe compatible configuration.

In some embodiments, the eyepiece removably couples to the optic.

In some embodiments, each of the one or more recesses includes a metal insert, wherein the one or more aperture magnets extend within a corresponding one of the one or more recesses and magnetically couple to a corresponding one of the one or more metal inserts.

In some embodiments, the eyepiece is configured to press fit onto the optic.

In some embodiments, the system further includes an eyepiece cover, the eyepiece cover including a tapered plug configured to be inserted within the central opening of the eyepiece, and one or more cover magnets configured to magnetically couple to the one or more recesses of the eyepiece.

In some embodiments, the adapter further includes a near field communication chip configured to communicate with an internal near field communication antenna of the camera device such that a camera application of the camera device is activated when the adapter is brought into proximity with the camera device.

In a second aspect, an adapter for coupling an optic to a camera device includes a base including one or more magnets arranged within a plane of the base and configured to magnetically couple to one or more magnets of a camera device; and one or more first protrusions extending radially away from the base parallel to the plane of the base, each of the one or more first protrusions including an opening and one or more aperture magnets. The adapter is configured to removably secure and align one or more camera lenses of the camera device with an optic.

In some embodiments, the one or more magnets of the base are arranged in a circle along a first surface of the adapter.

In some embodiments, the one or more magnets of the base are arranged in a MagSafe compatible configuration.

In some embodiments, the adapter further includes one or more second protrusions extending radially away from the base parallel to the plane of the base, each of the one or more second protrusions including a stopping component configured to magnetically couple to a second magnet of the camera device, wherein each opening is configured to be aligned with at least one of the one or more camera lenses of the camera device when a corresponding one of the stopping components is aligned with the second magnet of the camera device.

In some embodiments, the one or more second protrusions extend radially away from the base at a position different than the first protrusions.

In some embodiments, each of the one or more first protrusions has a first centerline and each of the one or more second protrusions has a second centerline, wherein an angle between a first centerline and a second centerline corresponds to an angle between a first reference line extending between a center of the camera device and a center of one of the one or more camera lenses of the camera device and a second reference line extending between the center of the camera device and an alignment magnet of the camera device.

In some embodiments, the adapter is configured to rotate relative to the camera device and the one or more second protrusions are configured to secure the adapter in one or more secured positions relative to the camera device.

In some embodiments, the one or more aperture magnets are spaced radially around the opening.

In some embodiments, the one or more aperture magnets are arranged along a second surface of the adapter.

In some embodiments, the one or more aperture magnets are configured to magnetically couple to an eyepiece removably coupleable to the optic.

In some embodiments, the one or more aperture magnets are configured to magnetically couple at least one of the one or more optical lenses to the adapter and align the at least one of the one or more optical lenses with the opening.

In some embodiments, the adapter further includes a near field communication chip configured to communicate with an internal near field communication antenna of the camera device such that a camera application of the camera device is activated when the adapter is brought into proximity with the camera device.

### BRIEF DESCRIPTION OF THE DRAWINGS

These and other features, aspects, and advantages of the present application are described with reference to drawings of certain embodiments, which are intended to illustrate, but not limit, the present disclosure. It is to be understood that the attached drawings are for the purpose of illustrating concepts disclosed in the present application and may not be to scale.

FIG. 1 is an exploded view of an example digiscoping adapter having openings aligned with an optic, an eyepiece, an eyepiece cover, and a camera device.

FIG. 2. is a perspective view of the example digiscoping adapter of FIG. 1 coupled with a camera device.

FIG. 3. is a rear view of a camera device and a front view of the example digiscoping adapter of FIG. 1.

FIG. 4A is a rear view of the example digiscoping adapter of FIG. 1 coupled to a camera device in a first position.

FIG. 4B is a rear view of the example digiscoping adapter of FIG. 1 coupled to a camera device in a second position.

FIG. 4C is a rear view of the example digiscoping adapter of FIG. 1 coupled to a camera device in a third position.

FIG. 5 is a perspective view of the example digiscoping adapter of FIG. 1 coupled with an optic.

FIG. 6 is a perspective view of the optic and the eyepiece of FIG. 5.

FIG. 7 depicts perspective views of an eyepiece cover.

FIG. 8 is a perspective view of an eyepiece and an eyepiece cover

### DETAILED DESCRIPTION

In the following detailed description, reference is made to the accompanying drawings. In the drawings, similar symbols typically identify similar components, unless context dictates otherwise. Thus, in some examples, part numbers may be used for similar components in multiple figures, or part numbers may vary from figure to figure. The illustrative examples described herein are not meant to be limiting. Other examples may be utilized, and other changes may be made, without departing from the spirit or scope of the subject matter presented. It will be readily understood that the aspects of the present disclosure and illustrated in the figures, may be arranged, substituted, combined, and designed in a wide variety of different configurations by a person of ordinary skill in the art, all of which are made part of this disclosure.

Reference in the specification to “one example,” “an example,” or “in some examples” means that a particular feature, structure, or characteristic described in connection with the example is included in at least one example of the disclosure. Moreover, the appearance of these or similar phrases throughout the specification does not necessarily mean that these phrases all refer to the same example, nor are separate or alternative examples necessarily mutually exclusive. Various features are described herein which may be exhibited by some examples and not by others. Similarly, various requirements are described which may be requirements for some examples but may not be requirements for other examples.

Generally described, aspects of the present disclosure relate to improving systems, devices, and methods for digiscoping including systems and adaptors for coupling optical devices with camera devices. Digiscoping involves using a camera to capture or record images of distant objects through an eyepiece of an optic or optical magnification device. Misalignment between the eyepiece, the optical magnification device, and/or the camera of the camera device can dramatically degrade image quality, causing blurring, distortion, and optical aberrations.

Digiscoping systems have been developed to mitigate misalignment and provide imaging enhancement. For example, some digiscoping systems may include a base structure or a case that envelops the camera device for ensuring proper alignment of the camera lens with a corresponding lens cover. Accordingly, a user must utilize the digiscoping system to facilitate a mechanical coupling between the base structure and the lens cover. This approach restricts users who prefer not to use a case for their camera device or who prefer a different case.

Some digiscoping systems may also require a lens cover to block unused lenses of the camera device when coupled with the digiscoping system. To return to a normal use of the camera device, a user may be required to decouple the base structure from the lens cover. For example, the digiscoping system may employ a latching mechanism to connect to an optic. Actuating the latching mechanism may require a torque and/or a force that can misalign the optic with the camera lens potentially causing the user to miss a shot and/or capture or record a degraded image. Additionally, some digiscoping systems lack the ability to target different lenses on the camera device. This is a significant drawback, as modern smartphones often feature multiple lenses, such as telephoto or zoom lenses that, when combined with an optic, provide enhanced zoom capabilities for superior image and video capture.

Some digiscoping systems require interlocking magnets in both the eyepiece and the adapter. The magnets increase manufacturing costs and risk attracting metal debris that could damage the optic. Moreover, the use of magnets in the eyepiece may interfere with components of certain optics having electronic components or other components susceptible to magnetic interference, such as an internal compass in electro-optical devices, rangefinders, rangefinding binoculars, or the like.

These and other drawbacks may render a digiscoping system burdensome, ineffective, and/or undesirable for their intended use with slower setup times, misalignment, and missed photographic opportunities. Certain embodiments of the present disclosure can solve these and other problems by providing a digiscoping system that allows the user to quickly and easily align an optic to the digiscoping system without exerting a force that could disturb the optical alignment. In some examples, the digiscoping system can use magnets to allow the user to quickly and easily align the optic to the digiscoping system while also reducing a requisite number of magnetic connections. For example, the digiscoping system can include an eyepiece that quickly and easily attaches to an optic and an adapter and an eyepiece cover that quickly and easily attaches to the eyepiece. Additionally, the digiscoping system can pivot to enable the use of multiple camera lenses on camera devices equipped with more than one camera lens. The resulting digiscoping system can thereby minimize damage to the optic (e.g., from direct contact or debris), minimize the weight of the system, and can be connected and removed without exerting a force that could disturb optical alignment.

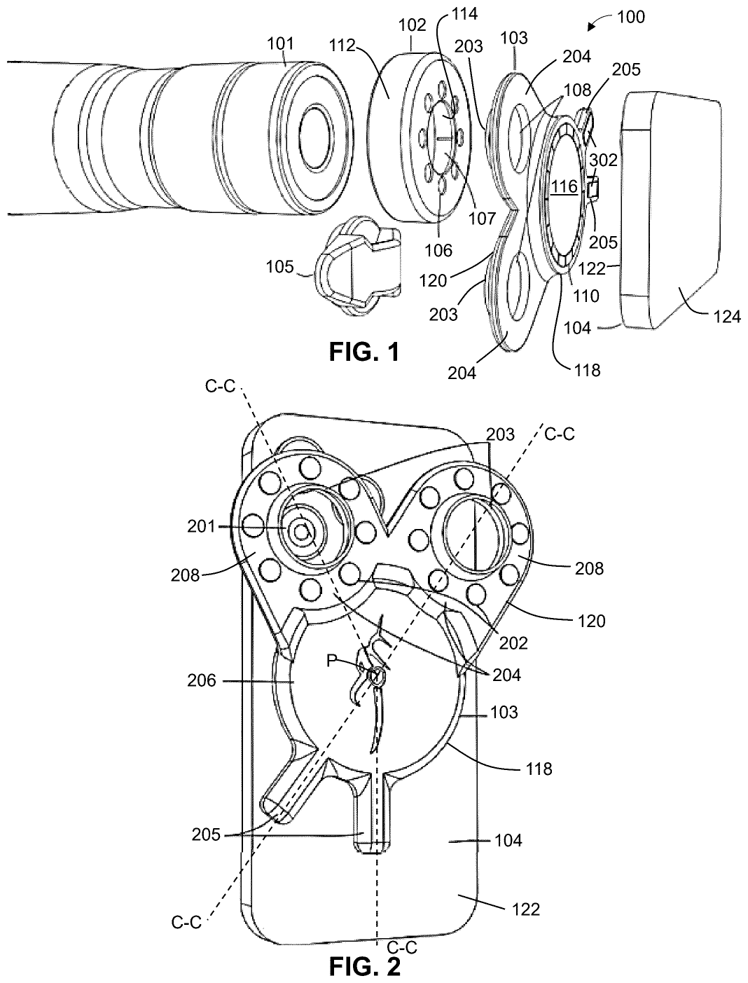

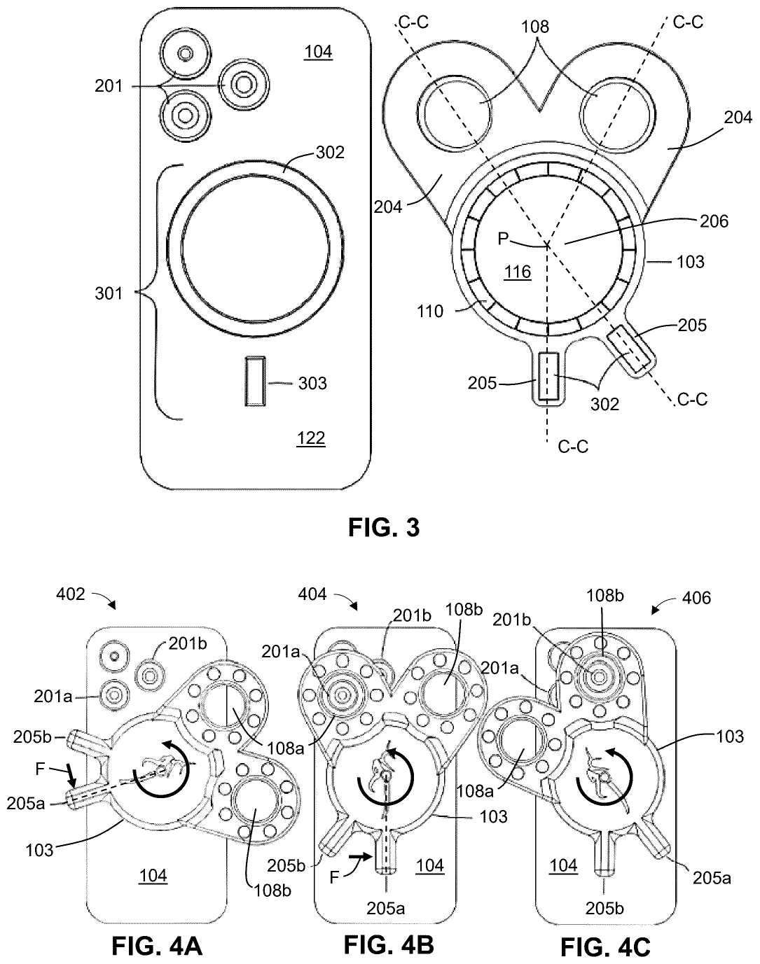

FIG. 1 is an exploded view of an example digiscoping system 100. The digiscoping system 100 shown in FIG. 1 includes an eyepiece 102, an adapter 103, and an eyepiece cover 105. The digiscoping system 100 can be used to align and couple one or more optics 101 with a camera device 104. FIG. 2 is a perspective view showing the adapter 103 coupled to the camera device 104. FIG. 3 illustrates a rear face of the camera device 104 and a front view of the adapter 103 showing the face of the adapter configured to magnetically couple to the rear face of the camera device 104. The following description refers jointly to FIGS. 1-3.

The optic 101 may include an elongated tubular body at a proximal end suitable for coupling to the eyepiece 102. The optic 101 can be configured to enhance optical imaging and vision. In some examples, the optics 101 can use reflection and/or refraction to manipulate light for magnifying or otherwise enhancing images. An optic 101 can further include mirrors, lenses, and other devices used to reflect and/or refract light from a first end to a second end. For example, the optics 101 can be telescopes, binoculars, microscopes, magnifying devices, or any other optical device for which alignment with a lens of an imaging device is desired. Accordingly, the optics 101 can be configured to receive light through the first end. The light can be reflected and refracted through the tubular body of the optics 101 before being output through an optical lens at the second end.

The eyepiece 102 can be an annular ring-shaped body. The eyepiece 102 can be configured to releasably engage the optic 101 and the adapter 103. The eyepiece 102 can include an outer annular surface 112 and an inner annular surface 114. The inner annular surface 114 can define a central opening 107 extending through the thickness of the eyepiece 102. In an operational state, the central opening 107 may be concentric with an aperture or optical axis of a corresponding optic 101. The eyepiece 102 can further include one or more dimples or recesses 106. In some examples, the recesses 106 can be referred to as an engagement element. For example, the recesses 106 can be a mechanical engagement element configured to mechanically couple with another mechanical engagement element. The recesses 106 can be arranged around the central opening 107. In some examples, the recesses 106 can be disposed within a face of the eyepiece 102. For example, the recesses can be disposed within a proximal face of the eyepiece 102 configured to engage the adapter 103. In some examples, the eyepiece 102 can be integrated into the adapter 103. In some examples, the eyepiece 102 can be integrated into the optic 101. In some examples, the adapter 103 can attach directly to the optic 101. Accordingly, in such examples, the adapter 103 may be coupled to the optic 101 via a mechanical and/or magnetic connection without the use of the eyepiece 102.

The adapter 103 can be configured to couple two devices together. In some examples, the adapter 103 may be used to couple optics to a camera device 104. For example, the adapter 103 may couple to the eyepiece 102 and to the camera device 104. In some examples, the adapter 103 may couple to the eyepiece 102 and/or the optic 101 regardless of the relative physical orientation of the camera device 104 (e.g., portrait, landscape, etc.). The adapter 103 can include a body and one or more one or more openings 108 disposed in the body. The adapter 103 can include any number of openings 108. For example, the adapter 103 can include one, two, three, or more openings 108. The number of openings 108 can correspond to a number of camera lenses 201 of the camera device 104. In some examples, the number of openings 108 can be fewer than the number of camera lenses 201. For example, a single opening 108 may be used with multiple camera lenses 201. In some examples, the adapter 103 can further include one or more raised edges 203. The raised edges 203 can protrude outward from the adapter 103. The number of raised edges 203 can correspond to the number of openings 108. For example, the raised edges 203 can be positioned radially outward from a corresponding opening 108.

The body can include one or more front magnets 110. In some examples, the front magnets 110 can include ferromagnetic material. In some examples, one or more metal pieces (or other magnetic pieces) may be used as an alternative to the front magnets 110. The front magnets 110 can be disposed along a first surface 116 of the body. In some examples, the front magnets 110 can extend annularly along the first surface 116 of the body. For example, the front magnets 110 can be arranged in a circular or ring pattern along the first surface 116 of the adapter 103. The first surface 116 of the adapter 103 may be configured to face and/or engage another device. For example, the front magnets 110 can be configured to magnetically couple with another device, such as with the camera device 104 as described in greater detail herein with reference to FIG. 3. In some embodiments, only a single front magnet 110 may employed to connect the adapter 103 to the camera device 104.

The body of the adapter 103 can have a basic geometric shape such as a circle, rectangle, triangle, or any other polygon. In some examples, the body can have a complex shape. For example, as shown in FIGS. 1-3, the body can include a base 206 and a plurality of lateral protrusions extending from the base 206. In some examples, the first surface 116 of the adapter 103 can be planar or substantially planar regardless of the shape of the body.

The base 206 can be a central hub of the adapter 103. The base 206 can include the front magnets 110. Accordingly, the base 206 can be used for magnetically coupling the adapter 103 to the camera device 104. As shown in FIG. 1, the base 206 can be a circular body having an outer annular edge. The front magnets 110 can be arranged in a ring pattern along the first surface 116 of the base 206 arranged radially inward from the outer annular edge.

The plurality of lateral protrusions can be used to couple an optic to the adapter and/or for operating the adapter 103. The lateral protrusions can extend laterally from an annular surface 118 of the base 206. In some examples, the lateral protrusions may extend radially from the outer annular edge of the base 206. For example, each of the lateral protrusions can include a radial centerline C-C that intersects a center point P of the base 206, as shown in FIG. 2.

The plurality of lateral protrusions can include one or more first protrusions 204. The first protrusions 204 can be configured to couple attachments to the adapter 103, such as an eyepiece for connecting to an optic. In some embodiments, the first protrusions 204 may be raised relative to the base 206. For example, the first protrusions 204 may extend radially outward from the annular edge of a second surface 120 of the base 206 opposite the front magnets 110. The second surface 120 of the base 206 can include recesses. For example, the second surface 120 of the base 206 along the first protrusions 204 can be a recessed surface 208.

The first protrusions 204 can include aperture magnets 202. In some examples, the aperture magnets 202 can be referred to as an engagement element. For example, the aperture magnets 202 can be a magnetic engagement element configured to magnetically couple to another magnetic engagement element and/or a mechanical engagement element configured to mechanically couple with another mechanical engagement element. The aperture magnets 202 can extend annularly around the openings 108. In some examples, the aperture magnets 202 can be arranged in a ring pattern along the second surface 120 of the adapter 103. The second surface 120 of the adapter 103 can be opposite the first surface 116 and may be configured to engage with another device. For example, the aperture magnets 202 can be configured to magnetically couple with the eyepiece 102. In some embodiments, the aperture magnets 202 can be singular magnets positioned adjacent to each of the openings 108. In some embodiments, the aperture magnets 202 are ring-shaped magnets that surround each opening 108.

Each of the first protrusions 204 can include one or more apertures, lumens, or openings 108. In an operable state, the openings 108 can be concentric with a central opening 107 of a corresponding eyepiece 102. Each of the first protrusions 204 can include any number of openings 108. For example, each of the first protrusions 204 can include one, two, three, or more openings 108. Each opening can correspond to a position of a corresponding lens of the camera device 104. As shown in FIG. 1, each of the first protrusions 204 includes only one opening 108. Accordingly, each of the first protrusions 204 can correspond to a camera lens 201 of the camera device 104. In other examples, each of the first protrusions 204 can be configured to engage multiple camera lenses 201. Each of the first protrusions 204 can further include one or more aperture magnets 202 as described in greater detail herein with reference to FIG. 2. In some examples, the number of the first protrusions 204 can correspond to the number of camera lenses 201 that can be engaged with the adapter 103. For example, each first protrusion 204 may include one opening 108. In some examples, the number of first protrusions 204 can be less than the number of camera lenses. For example, each first protrusion 204 may include two or more openings 108. In some examples, the adapter 103 can include a single first protrusion 204 having a single opening 108. The first protrusion 204 can be moved during operation to align the opening 108 with multiple different camera lenses 201 on the camera device 104. Whether the openings 108 are all provided in an individual first protrusion 204, or each opening 108 is provided in a single first protrusion 204 (or some combination thereof) the adapter 103 can be arranged such that when the adapter 103 is properly connected to the camera device 104, the opening 108 can moved into alignment with a camera lens 201 on the camera device 104. In some examples, each opening 108 can be simultaneously aligned with corresponding camera lenses 201.

In some examples, the first protrusions 204 may be removable from the base 206. In some embodiments the first protrusions 204 may pivot or otherwise move about the adapter 103 or the base 206. Accordingly, the location of the first protrusions 204 relative to the base 206 can be adjusted for facilitating alignment between the openings 108 and corresponding camera lenses 201 of the camera device 104. In some examples, the adapter 103 may not include the first protrusions 204 and/or the second protrusions 205. Instead, the openings 108 may be disposed within the base 206 of the adapter 103

The plurality of lateral protrusions can further include one or more second protrusions 205. In some embodiments, the second protrusions 205 may be level relative to a surface of the base 206. For example, the second protrusions 205 may extend radially outward from the annular edge of the first surface 116 of the base 206 having the front magnets 110. The second protrusions 205 can be configured to secure the adapter 103 in a position relative to the camera device 104 as described in greater detail herein with reference to FIG. 3.

The plurality of lateral protrusions can include any number of first protrusions 204 and any number of second protrusions. For example, the plurality of lateral protrusions can include one, two, three, four, or more first protrusions 204 and one, two, three, four, or more second protrusions 205. In some examples, the number of first protrusions 204 and the number of second protrusions can be the same. In some examples, the second protrusions 205 may extend from the base 206 at a location different from a corresponding first protrusion 204 such that each first protrusion 204 can be annularly separated by its corresponding second protrusion 205.

The camera device 104 can be an electronic device having a camera system. In some examples, the camera device 104 can be a mobile device. For example, the camera device 104 can be a smartphone, tablet, or other camera enabled personal device. In various emboidments, the camera device 104 can be any type of imaging device including suitable magnetic components for coupling to the adapter 103, and/or can be an imaging device within a case having such magnetic components.

The camera device 104 can include one or more camera lenses 201. The camera device 104 can include any number of camera lenses 201. For example, the camera device 104 can include one, two, three, or more camera lenses 201. The camera lenses 201 can have different features and/or may be different types of lenses. For example, the camera lenses 201 can include any combination of one or more of a wide angle lens, an ultrawide lens, a telephoto lens, a macro lens, a thermal imaging lens, or any other type of lens. Each camera lens 201 can offer a different perspective and focal length. The camera lenses 201 can be positioned along one or more surfaces of the camera device 104. For example, camera lenses 201 may be positioned on a rear surface 122 and/or a front surface 124 of the camera device 104. The camera device 104 can further include a device magnet 301 as described in greater detail herein with reference to FIG. 3. Additionally, in some examples, the camera device 104 can be equipped with an internal Near Field Communication (NFC) antenna. The internal NFC antenna can be configured to receive communication signals.

In an operating state, the adapter 103 can be removably attached to the camera device 104 via a magnetic connection between the front magnets 110 of the adapter 103 and the device magnet 301 in or on the camera device 104 as described in greater detail herein with reference to FIG. 3. In some embodiments, the adapter 103 can be equipped with an NFC chip. When the adapter 103 is brought into proximity with the camera device 104, the NFC chip can communicate with the internal NFC antenna of the camera device 104. Communication with the internal NFC antenna of the camera device 104 can activate the camera system of the camera device 104. For example, communication between the NFC chip of the adapter 103 and the NFC antenna of the camera device may launch a camera app of the camera device 104.

The eyepiece cover 105 can be configured to cover and protect a lens of the digiscoping system 100 and to block ingress of dust and debris. In some examples, the eyepiece cover 105 can be configured to protect an optical lens 501. For example, the eyepiece cover 105 can be configured to cover the optical lens 501 of the optic 101 and to be received within the central opening 107 of the eyepiece 102. Thus, the optic 101 can safely be stored with the eyepiece 102 of the digiscoping system installed on the optic 101 by using the eyepiece cover 105 and the eyepiece 102 in place of a manufacturer-supplied cover for the optic 101.

As shown in FIG. 2, one of the openings 108 of the adapter 103 can be aligned with a camera lens 201 of the camera device 104. A user may rotate the adapter 103 about the base 206 by applying a force F to the second protrusions 205. For example, the force F applied to the second protrusions 205 perpendicular to their longitudinal axes passing through a center point P of the base 206 can rotate the adapter 103. As described herein with reference to FIGS. 1 and 3, the magnetic connection between the adapter 103 and the camera device 104 can be accomplished via a circular arrangement of the corresponding magnets. The circular arrangement of the magnets can facilitate the rotation of the adapter 103. Rotating the adapter 103 relative to the camera device 104 can facilitate alignment of other openings 108 with another camera lens 201 as described in greater detail herein with reference to FIGS. 4A-4C.

As further shown in FIG. 2, the aperture magnets 202 of the adapter 103 can annularly surround each of the openings 108 disposed within the first protrusions 204. For example, the aperture magnets 202 may be positioned radially outward from the raised edges 203. In some examples, the aperture magnets 202 can protrude outward from the second surface 120 of the first protrusions 204. In some examples, the aperture magnets 202 may be level with the second surface 120 of the adapter 103. As described herein with reference to FIG. 1, the second surface 120 of the adapter 103 can be recessed along the first protrusions 204. In some examples, the aperture magnets 202 may be located within the recesses of the first protrusions 204. As shown in FIG. 2, the aperture magnets 202 can be a plurality of distinct magnets positioned adjacent to one another around each of the openings 108. In some examples, the aperture magnets 202 can be ring-shaped and sized to surround a corresponding opening 108. Accordingly, the aperture magnets 202 can be one or more magnets positioned annularly around a corresponding opening 108.

With further reference to FIG. 3, the camera device 104 can include a device magnet 301. The device magnet 301 can include a circular magnet and an alignment magnet 303. The device magnet 301 can magnetically couple the camera device 104 to one or more different devices. The device magnet 301 may be configured to align and securely attach accessories to the camera device 104 and/or provide wireless charging to the camera device 104. In some examples, the device magnet 301 can be configured to magnetically couple cases, wallets, mounts, adapters, and other devices to the camera device 104. For example, the device magnet 301 can include a circular portion 302 that can be magnetically coupled with the front magnet 110 of the adapter 103. The circular portion 302 can be formed from a plurality of discrete magnetic elements. The discrete magnetic elements may be arranged in an annular pattern disposed along a rear surface 122 of the camera device 104. In some embodiments, the device magnet 301 on the camera device 104 can meet the MagSafe standard (or functional equivalent thereof). In some embodiments, the camera device 104 may be enveloped by a case. In some embodiments, the device magnet 301 can be provided in or on a case enveloping the camera device 104, instead of or in addition to a device magnet 301 located on the camera device 104 itself.

The device magnet 301 can include one or more alignment magnets 303. The alignment magnet 303 can be positioned relative to the circular portion 302 of the device magnet 301. In some examples, the alignment magnets 303 can be positioned radially outward from the circular portion 302 of the drive magnet 301. For example, the alignment magnets 303 can extend in a radial direction away from the circular portion 302 of the drive magnet 301. The alignment magnets 303 can be configured to automatically align the camera device 104 with a compatible accessory.

As described herein with reference to FIG. 1, the adapter 103 can include any number of first protrusions 204. As shown in FIG. 3, the adapter 103 can include two first protrusions 204. Each of the first protrusions 204 can include an opening 108 configured to align with a corresponding camera lens 201. Accordingly, the openings 108 can include a first opening and a second opening. The first opening can be configured to align with a first one of camera lenses 201. The second opening can be configured to align with a second one of camera lenes 201. For example, as shown in FIG. 3, this configuration can be achieved by locating the openings 108 at different radial distances from the center of the ring of the front magnet 110 and/or at different angular displacements relative to the corresponding stopping components 302.

Referring now to FIGS. 3 and 4A-4C, the adapter 103 can include any number of second protrusions 205. The number of second protrusions 205 can correspond to the number of first protrusions 204. For example, as shown in FIG. 4A, the adapter 103 can include two second protrusions 205. As shown in FIGS. 4A-4C, the second protrusions 205 can include a first protrusion 205a and a second protrusion 205b. In some examples, the second protrusions 205 may be positioned angularly from the base 206 at a location different from a corresponding first protrusion 204. The angle between radial centerlines C-C of the first protrusions 204 and the corresponding second protrusions 205 can depend on the position of the corresponding camera lens 201 relative to the alignment magnets 303. For example, the camera lenses 201 each have a vertical and horizontal distance from the alignment magnet 303. Accordingly, the angle between corresponding openings 108 and stopping components can correspond to the angle between a reference line extending between a center of the circular portion 302 of the device magnet 301 and the center of the corresponding camera lens 201 and a second reference line extending between the center of the circular portion 302 of the device magnet 301 and the center of the alignment magnet 303.

The front magnets 110 can be arranged in a circular arrangement. The size and shape of the circular arrangement of the front magnets 110 can correspond to the arrangement of the circular portion 302 of the device magnet 301. In some examples, the front magnets 110 can be arranged to connect to a MagSafe standard (or functional equivalent thereof). Accordingly, the front magnets 110 can be configured to magnetically engage the circular portion 302 of the device magnet 301. For example, front magnets 110 can be configured to magnetically couple to the circular portion 302 of the device magnet 301. The circular arrangement of the front magnets 110 and the circular portion 302 of the device magnet 301 can allow the adapter 103 to rotate relative to the camera device 104 in a coupled state.

As further shown in FIG. 3, the first surface 116 of each of the second protrusions 205 can include the stopping components 302. The stopping components 302 can be configured to magnetically engage the alignment magnets 303. The stopping components 302 can maintain a relative rotational position between the adapter 103 and the camera device 104. For example, a magnetic coupling between the stopping components 302 and the alignment magnets 303 can secure the adapter 103 in a relative rotational position. The magnetic coupling between the stopping components 302 and the alignment magnets 303 may be overcome by providing a force F perpendicular to a central axis of the corresponding second protrusions 205. Accordingly, a user may apply a force F to selectively overcome the magnetic coupling between the stopping components 302 and the alignment magnets 303.

Accordingly, each second protrusion 205 can correspond to a magnetically locked or secured position for securely aligning a corresponding opening 108 with a corresponding camera lens 201. Additionally, the adapter 103 can satisfy the MagSafe standard (or functional equivalent thereof) and/or be magnetically coupled to another device employing the MagSafe standard (or functional equivalent thereof).

FIGS. 4A-4C illustrate the adapter 103 connected to a camera device 104 in different rotational positions. The adapter 103 can rotate relative to the camera device 104 for aligning the openings 108 with different camera lenses 201. For example, FIGS. 4A-4C illustrate the adapter 103 in different positions relative to the camera device 104 when the front magnets 110 of the adapter 103 couple with the device magnet 301 of the camera device 104.

FIG. 4A illustrates the adapter 103 connected to the camera device 104 in a first position 402. The first position 402 can correspond to a non-aligned state. For example, none of the openings 108 are aligned with a corresponding camera lens 201 and neither second protrusion 205a, 205b is aligned with the alignment magnet 303 (FIG. 3). The adapter 103 can be rotated relative to the camera device 104 to transition the adapter 103 from the first position 402 to another position. For example, a force F can be applied to the second protrusions 205 and/or to the first protrusions 204 to rotate the adapter 103 relative to the camera device 104.

FIG. 4B illustrates the adapter 103 connected to the camera device 104 in a second position 404. The second position 404 can correspond to a first aligned state. In the first aligned state, a first opening 180a can be aligned with the first camera lens 201a. The second position 404 can be achieved by rotating the adapter 103 relative to the camera device 104 such that second protrusion 205a is aligned with the alignment magnet 303 (FIG. 3). Upon reaching the second position of FIG. 4B, the magnetic stopping component 302 (FIG. 3) in second protrusion 205a can engage with the alignment magnet 303 to lock or retain the adapter 103 in the second position 404. The adapter 103 is locked or retained in the second position 404 such that a greater force F is needed to move the adapter 103 from the second position than would otherwise be required to rotate the adapter 103 when not in an aligned state.

FIG. 4C illustrates the adapter 103 connected to the camera device 104 in a third position 406. The third position 406 can correspond to a second aligned state. In the second aligned state, a second opening 180b can be aligned with the second camera lens 201b. The third position 406 can be achieved by rotating the adapter 103 relative to the camera device 104 such that second protrusion 205b is aligned with the alignment magnet 303 (FIG. 3). Upon reaching the third position 406 of FIG. 4C, the magnetic stopping component 302 (FIG. 3) in second protrusion 205b can engage with the alignment magnet 303 to lock or retain the adapter 103 in the third position 406. The adapter 103 is locked or retained in the third position 406 such that a greater force F is needed to move the adapter 103 from the third position 406 than would otherwise be required to rotate the adapter 103 when not in an aligned state.

Accordingly, the second protrusions 205a, 205b having magnetic stopping components 302 therein can provide an adapter that rotationally toggles between different aligned states that align an opening 180a, 180b with one of a plurality of lenses on the imaging device with the optical axis of a desired optic. The locking or retaining alignment between the stopping component and the alignment magnet of the imaging device 104 allows a user to easily align the optic with a desired lens of the imaging device without having to adjust fine-tune the alignment manually. In other embodiments, the adapter 103 can include any number of first and second protrusions configured to align an opening with a camera lens. For example, the adapter 103 can include a single opening and second protrusion, or can include any number greater than 2 different alignment status, dependent, for example, on the number of lenses included in a camera device. In one non-limiting example, the adapter 103 of FIGS. 4A-4C could include a third first protrusion and a third second protrusion configured to align the third first protrusion with the third lens of the camera device 104.

The adapter 103 can have any number of possible positions. In some examples, each opening 108 may be configured to align with multiple camera lenses 201. Accordingly, each position of the adapter 103 relative to the camera device 104 can correspond to an alignment between an opening 108 and a corresponding camera lens 201. As shown in FIGS. 4A-4C, the adapter 103 can be rotated relative to the camera device 104 while maintaining a magnetic coupling. In some examples, the base 206 of the adapter 103 can remain stationary while another portion of the adapter 103 rotates. For example, the lateral protrusions can rotate relative to the base 206. The stopping components 302 can secure the adapter 103 in different positions relative to the camera device 104. For example, the stopping components 302 can locked or secure position the adapter 103 in the relative positions.

Other examples for positioning or aligning the openings 108 with the camera lenses 201 can be used. In some examples, a hinge may be implemented to connect the base 206 and the first protrusions 204. The hinge can enable the first protrusions 204 to rotate or pivot relative to the base 206. For example, the first protrusions 204 may rotate or pivot annularly around the base 206 while remaining within a common plane with the base 206. Rotating or pivoting the first protrusions 204 can allow at least one opening 108 to become aligned with a corresponding camera lens 201. In some examples, the adapter 103 may utilize a sliding rail. The sliding rail may allow the first protrusions 204 to slide along the base 206. For example, the sliding rail may allow the first protrusions 204 to translate along a first axis and/or a second axis of the plane of the base 206. Sliding the first protrusions 204 along the base 206 can allow at least one opening 108 to become aligned with a camera lens 201. In some examples, the adapter 103 may utilize a combination of the sliding rail and hinge connecting the base 206 and first protrusions 204. In these examples, the adapter 103 may be configured so as to limit the movability of the first protrusions 204 once at least one of the openings 108 is aligned with a camera lens 201. Immobilizing the first protrusions 204 can enable the aligned opening 108 to enjoy a fixed alignment position. In some examples, the first protrusions 204 can be removable. In such examples, the first protrusions 204 may be installed in fixed positions that align at least one opening 108 with a camera lens 201. In some examples, the openings 108 may rotate. In such examples, at least a portion of the base 206 can remain stationary relative to the openings 108 as the openings 108 rotate.

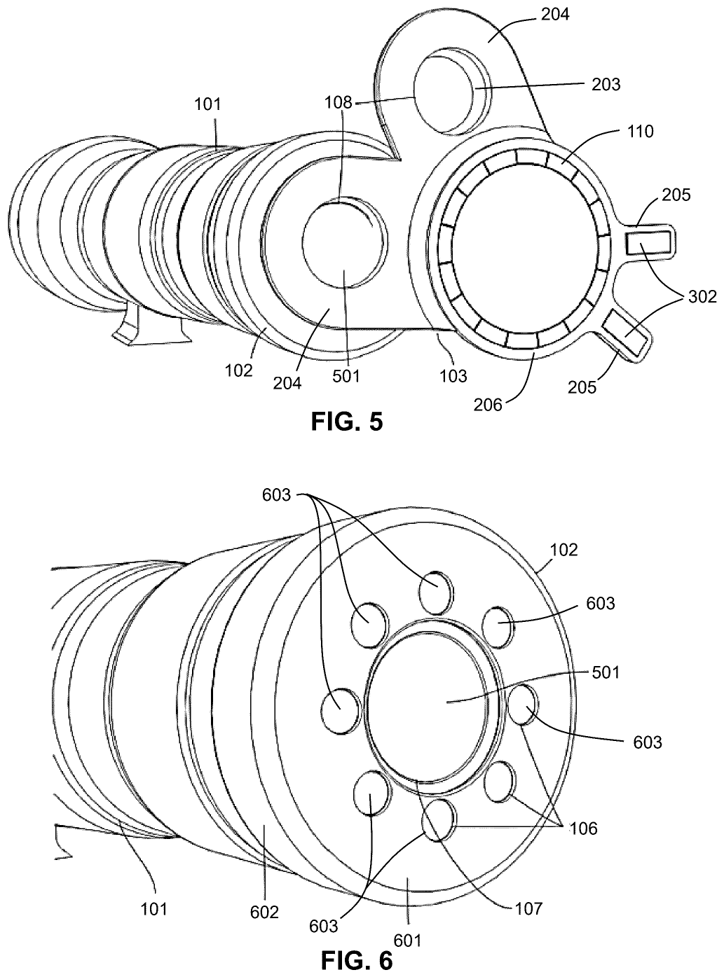

FIGS. 5 and 6 illustrate the connections between the adapter 103, the eyepiece 102, and the optic 101. The eyepiece 102 can be coupled to the optic 101. In some examples, the eyepiece 102 can be press-fit onto the optic 101. For example, the eyepiece 102 can be secured to the optic 101 via a frictional force between the optic 101 and a wall 602 of the eyepiece 102. In some examples, the eyepiece 102 can be secured to the optic 101 with an adjustable clamp, set screw, adhesive, or any other suitable interface. As shown in FIG. 5, the openings 108 of the adapter 103 can be aligned with the central opening 107 of the eyepiece 102, and with a corresponding optical lens 501 of the optic 101. Accordingly, in an assembled state when the adapter 103 is further coupled with the camera device 104, the optical lens 501 of the optic 101 can be securely aligned with a camera lens of the camera device.

FIG. 6 illustrates a close up view of the proximal end of the eyepiece 102. The eyepiece 102 is coupled to the optic 101 as described herein with reference to FIG. 5. As shown in FIG. 6, the central opening 107 of the eyepiece 102 can be aligned with the optical lens 501 of the optic 101. As further shown in FIG. 6, the eyepiece 102 can include a proximal face 601. In some examples, an arrangement of inserts 603 can be disposed within the distal face 601 of the eyepiece 102. In some examples, the inserts 603 can be referred to as an engagement element. For example, the inserts 603 can be a metallic and/or magnetic engagement element configured to mechanically couple with another magnetic engagement element. For example, the inserts 603 may be positioned within corresponding dimples or recesses 106 in the distal face 601. The inserts 603 can comprise any suitable material for magnetic coupling such as, for example, a ferromagnetic metallic material, a permanent magnet, and/or any magnetic material suitable for coupling to a permanent magnet. The inserts 603 may be steel plates. The inserts 603 can be configured to engage the aperture magnets 202 of the adapter 103 (see FIG. 2). In some examples, the metal inserts 603 can be sized and arranged to receive the aperture magnets 202 protruding from the first protrusions 204 (see FIG. 2) therein. For example, in an assembled state, the aperture magnets of the adapter 103 may be received within corresponding recesses 106 and magnetically couple to a corresponding insert 603.

Accordingly, the eyepiece 102 and the adapter 103 can be magnetically and mechanically coupled together. For example, a magnetic coupling can be formed between the aperture magnets 202 and the metal inserts 603 and the mechanical coupling can be formed between the aperture magnets 202 and the recesses 106. The magnetic and mechanical couplings can cooperate to both longitudinally couple the adapter 103 to the eyepiece 102 (e.g., by magnetically preventing the adapter and eyepiece from moving apart along the optical axis of the optic) and rotationally couple the adapter 103 to the eyepiece 102 (e.g., by mechanically preventing the adapter from rotating relative to the eyepiece).

The exact arrangement and configuration of the recesses 106, the aperture magnets 202, and the inserts 603 may differ without deviating from the spirit and scope of the present disclosure. For example, the inserts 603 may protrude out from the distal face 601 of the eyepiece 102 and into aperture magnets 202 located within recesses in the first protrusions 204. In some examples, the inserts 603 and the aperture magnets 202 may be level with the distal face 601 of the eyepiece 102 and the first protrusion 204, respectively. In such examples, the connection between the eyepiece 102 and the adapter 103 can be purely magnetic. In some examples, the inserts 603 can be formed from ferromagnetic materials. In some examples, the recesses 106 may include a metal. For example, the recesses 106 may be coated in metal. Accordingly, the aperture magnets 202 may magnetically attach to the metal-coated recesses 106. In some examples, the location of the aperture magnets 202 and the recesses 106 may be switched. For example, the aperture magnets 202 may be located in the eyepiece 102 and the recesses 106 (either metal-coated or with metal inserts 603) may be located in the adapter 103. In such examples, the aperture magnets 202 can extend annularly around the central opening 107 of the eyepiece 102. In some examples, the aperture magnets 202 could be arranged in a ring pattern along the distal face 601 of the eyepiece 102. For example, the aperture magnets 202 can be arranged in the same annular pattern as the recesses 106 of the eyepiece 102 shown in FIG. 6.

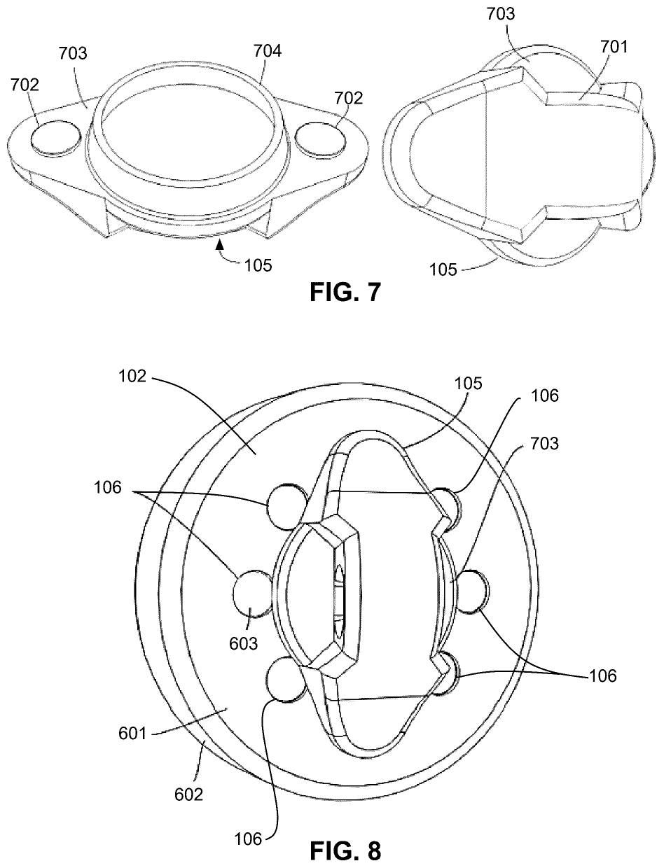

FIGS. 7 and 8 illustrate an embodiment of an eyepiece cover 105. FIG. 7 depicts two views of an example eyepiece cover 105, and FIG. 8 depicts the example eyepiece cover 105 attached to an eyepiece 102. As described herein with reference to FIG. 1, the eyepiece cover 105 can be configured to cover and protect a lens of the digiscoping system 100 and to block ingress of dust and debris. The eyepiece cover 105 can include a pinch handle 701, one or more cover magnets 702, a cover body 703, and a tapered plug 704.

The pinch handle 701 is an elongated protrusion of the eyepiece cover 105. The pinch handle 701 can be configured to facilitate grasping, removal, and handling of the eyepiece cover 105. For example, the pinch handle 701 can include indents sized and configured to receive opposing fingers from a user. The user can thus engage two sides of the pinch handle 701 to firmly grasp the eyepiece cover 105. After grasping the pinch handle 701, the user may remove the eyepiece cover 105 from the optic 101 and/or the eyepiece 102. In some examples, the user may grasp the pinch handle 701 to position the pinch handle 701 into engagement with the optic 101 and/or the eyepiece 102.

The cover magnets 702 can be a ferromagnetic material. The cover magnets 702 can be configured to releasably secure the eyepiece cover 105 to the optic 101 and/or the eyepiece 102. For example, the cover magnets 702 can have the same or similar shape and material composition to the individual aperture magnets 202 of the adapter 103 (see FIG. 2). As shown in FIG. 7, the cover magnets 702 can be positioned on the pinch handle 701. In some examples, the cover magnets 702 may be arranged along a longitudinal axis of the eyepiece cover 105 at opposing radial positions about the tapered plug. The cover magnets 702 can be sized and configured to engage a corresponding magnet or metal insert of the optic 101 and/or the eyepiece 102. As shown in FIG. 7, the cover magnets 702 can be embedded within the cover body 703. In some embodiments, the cover magnets 702 may protrude out from the eyepiece cover 105. The cover magnets 702 can be positioned to magnetically couple to the metal inserts 603 within the recesses 106. In some examples, the cover magnets 702 may physically couple to the recesses 106 in the eyepiece 102 via a frictional force between the recesses 106 and the eyepiece cover 105. The magnetic and/or mechanical coupling can enable a rapid, tool-free attachment and removal of the eyepiece cover 105. In some embodiments, the cover magnets 702 may be located within recesses of the eyepiece cover 105. In such examples, the metal inserts 603 may protrude out from the eyepiece 102 and into the recesses in the eyepiece cover as described herein with reference to FIG. 6 regarding the eyepiece 102 and the adapter 103.

The exact arrangement and configuration of the recesses 106, the cover magnets 702, and the metal inserts 603 may differ without deviating from the spirit and scope of the present disclosure. For example, the metal inserts 603 may protrude out from the distal face 601 of the eyepiece 102 and into cover magnets 702 located within recesses in the eyepiece cover 105. In some examples, the metal inserts 603 and the cover magnets 702 may be level with the distal face 601 of the eyepiece 102 and the eyepiece cover 105, respectively. In such examples, the connection between the eyepiece 102 and the eyepiece cover 105 can be purely magnetic. In some examples, the metal inserts 603 can be formed from ferromagnetic materials. In some examples, the recesses 106 may be include a metal. For example, the recesses 106 may be coated in metal. Accordingly, the cover magnets 702 may magnetically attach to the metal-coated recesses 106. In some examples, the location of the cover magnets 702 and the recesses 106 may be switched. For example, the cover magnets 702 may be located in the eyepiece 102 and the recesses 106 (either metal-coated or with metal inserts 603) may be located in the eyepiece cover 105. In such examples, the cover magnets 702 can extend at least partially annularly around the central opening 107 of the eyepiece 102. For example, the cover magnets 702 may be positioned 180 degrees from one another. In some examples, the cover magnets 702 could be arranged in a ring pattern along the distal face 601 of the eyepiece 102 to also accommodate the adapter 103 as described herein with reference to FIG. 6. Accordingly, coupling the adapter 103 and the eyepiece cover 105 to the eyepiece 102 can be mutually exclusive. In some examples, the connection between the eyepiece cover 105 and the eyepiece 102 can be purely mechanical. For example, the eyepiece cover 105 can be coupled to the recesses 106 exclusively through a frictional force between the recesses 106 and the cover magnets 702, or through a frictional force between the metal inserts 603 and the recesses in the eyepiece cover 105. In some examples, the eyepiece 102 can provide a mechanical retention feature that engages a complementary feature on the cover body 703 while the tapered plug 704 is positioned within the central opening 207.

The cover body 703 is structural body configured to cover an optical lens 501. As shown in FIG. 7, the cover body 703 can be circular. The dimensions of the cover body 703 can be at least the same size as the central opening 107. For example, an outer diameter of the cover body 703 can exceed the outer diameter of the central opening 107 of the eyepiece 102.

The tapered plug 704 is a truncated conical body. The tapered plug 704 can be configured to be inserted within the central opening 107 of the eyepiece 102. For example, the truncated conical body of the tapered plug 704 can be sized to be received within the central opening 107 of the eyepiece 102. In some embodiments, the structure in the tapered plug 704 is concentrated, minimizing the thickness of the cover body 703 is minimized, thus providing a low-mass cover. In other embodiments, the walls of the tapered plug are not hollow, and the plug is solid.

Accordingly, the eyepiece cover 105 can be coupled to the eyepiece 102 to protect the optical lens 501 and to block ingress of dust and debris into the eyepiece 102 and/or the optic 101. Advantageously, the eyepiece cover 105 allows the eyepiece 102 to be stored on the optic 101 for long periods of time, including while the optic is not being used, without allowing dust or debris to enter the eyepiece 102 and occlude or dirty the lens of the optic 101.

FIG. 8 illustrates an embodiment in which the eyepiece cover 105 is magnetically and mechanically coupled to the eyepiece 102. As shown in FIG. 8, the cover body 703 overlies and protects the central opening 107 of the eyepiece 102. The tapered plug 704 can be positioned within the central opening 107. Accordingly, the tapered plug 704 can provide a frictional and/or sealing fit. The cover magnets 702 embedded in the cover body 703 can be configured to engage corresponding metal inserts 603 disposed in the recesses 106 of the eyepiece 102. Accordingly, the tapered plug 704 can provide a mechanical coupling and the cover magnets 702 can provide a magnetic coupling.

While the above detailed description has shown, described, and pointed out novel features, it can be understood that various omissions, substitutions, and changes in the form and details of the devices or algorithms illustrated can be made without departing from the spirit of the disclosure. Although the systems and devices disclosed herein are generally described with reference to digiscoping and/or other afocal photography methods and systems, it will be understood that the technology disclosed herein is not limited to such implementations and may equally be implemented in conjunction with any other type of optical or imaging system using any desired optical and/or imaging components, without departing from the spirit or scope of the present disclosure. As can be recognized, certain portions of the description herein can be embodied within a form that does not provide all of the features and benefits set forth herein, as some features can be used or practiced separately from others. The scope of certain implementations disclosed herein is indicated by the appended claims rather than by the foregoing description. All changes which come within the meaning and range of equivalency of the claims are to be embraced within.

What is claimed is:

1. A digiscoping system comprising:
an adapter comprising:
a base comprising one or more magnets configured to magnetically couple to one or more magnets of a camera device;
one or more openings;
one or more aperture magnets disposed about each of the one or more openings; and
one or more stopping components configured to align with an alignment magnet of the camera device; and
an eyepiece comprising a central opening and one or more recesses configured to be removably coupled to the one or more aperture magnets;
wherein the digiscoping system is configured to removably secure and align one or more camera lenses of the camera device with an optic when the eyepiece is coupled about an optical axis of the optic.

2. The system of claim 1, wherein the one or more magnets are arranged in a circle along a first surface of the adapter.

3. The system of claim 1, wherein the one or more front magnets are arranged in a MagSafe compatible configuration.

4. The system of claim 1, wherein the eyepiece removably couples to the optic.

5. The system of claim 1, wherein each of the one or more recesses comprises a metal insert, wherein the one or more aperture magnets extend within a corresponding one of the one or more recesses and magnetically couple to a corresponding one of the one or more metal inserts.

6. The system of claim 1, wherein the eyepiece is configured to press fit onto the optic.

7. The system of claim 1, further comprising an eyepiece cover, the eyepiece cover comprising:
a tapered plug configured to be inserted within the central opening of the eyepiece, and
one or more cover magnets configured to magnetically couple to the one or more recesses of the eyepiece.

8. The system of claim 1, wherein the adapter further comprises a near field communication chip configured to communicate with an internal near field communication antenna of the camera device such that a camera application of the camera device is activated when the adapter is brought into proximity with the camera device.

9. An adapter for coupling an optic to a camera device, the adapter comprising:
a base comprising one or more magnets arranged within a plane of the base and configured to magnetically couple to one or more magnets of a camera device; and
one or more first protrusions extending radially away from the base parallel to the plane of the base, each of the one or more first protrusions comprising an opening and one or more aperture magnets;
wherein the adapter is configured to removably secure and align one or more camera lenses of the camera device with an optic.

10. The adapter of claim 9, wherein the one or more magnets of the base are arranged in a circle along a first surface of the adapter.

11. The adapter of claim 9, wherein the one or more magnets of the base are arranged in a MagSafe compatible configuration.

12. The adapter of claim 9, further comprising one or more second protrusions extending radially away from the base parallel to the plane of the base, each of the one or more second protrusions comprising a stopping component configured to magnetically couple to a second magnet of the camera device, wherein each opening is configured to be aligned with at least one of the one or more camera lenses of the camera device when a corresponding one of the stopping components is aligned with the second magnet of the camera device.

13. The adapter of claim 12, wherein the one or more second protrusions extend radially away from the base at a position different than the first protrusions.

14. The adapter of claim 12, wherein each of the one or more first protrusions has a first centerline and each of the one or more second protrusions has a second centerline, wherein an angle between a first centerline and a second centerline corresponds to an angle between a first reference line extending between a center of the camera device and a center of one of the one or more camera lenses of the camera device and a second reference line extending between the center of the camera device and an alignment magnet of the camera device.

15. The adapter of claim 12, wherein the adapter is configured to rotate relative to the camera device and the one or more second protrusions are configured to secure the adapter in one or more secured positions relative to the camera device.

16. The adapter of claim 9, wherein the one or more aperture magnets are spaced radially around the opening.

17. The adapter of claim 9, wherein the one or more aperture magnets are arranged along a second surface of the adapter.

18. The adapter of claim 9, wherein the one or more aperture magnets are configured to magnetically couple to an eyepiece removably coupleable to the optic.

19. The adapter of claim 9, wherein the one or more aperture magnets are configured to magnetically couple at least one of the one or more optical lenses to the adapter and align the at least one of the one or more optical lenses with the opening.

20. The adapter of claim 9, further comprising a near field communication chip configured to communicate with an internal near field communication antenna of the camera device such that a camera application of the camera device is activated when the adapter is brought into proximity with the camera device.
